(19) United States
(12) Patent Application Publication
(10) Pub. No.: US 2014/0315172 A1
(43) Pub. Date: Oct. 23, 2014

(54) SYSTEMS AND METHODS FOR INTERACTIVE SCENARIO-BASED MEDICAL INSTRUCTION

(71) Applicant: Curtis Cheeks, JR., Dallas, GA (US)

(72) Inventor: Curtis Cheeks, JR., Dallas, GA (US)

(21) Appl. No.: 14/216,197

(22) Filed: Mar. 17, 2014

Related U.S. Application Data
(60) Provisional application No. 61/791,510, filed on Mar. 15, 2013.

(51) Int. Cl. G09B 23/28

(52) U.S. Cl. CPC G09B 23/28
USPC 434/262

(57) ABSTRACT

Systems and methods for providing a framework (e.g. software, hardware, firmware, etc.) allow students and health professionals to learn and practice medical principles and refine essential skills in a virtual environment. The disclosed framework allows students (users) to interact with virtual patients in various scenarios, exposing users to medical illnesses and conditions. For example, the disclosed framework allows users to identify and manage different illnesses and conditions that may not be common in their geographic location, and exposes users to patient types and ethnic groups that they may not be exposed to otherwise.

### CROSS REFERENCE TO RELATED APPLICATION

This application is a non-provisional application claiming priority from U.S. Provisional Application Ser. No. 61/791,510, filed Mar. 15, 2013, entitled “Systems and Methods for Interactive Scenario-Based Medical Instruction” and incorporated herein by reference in its entirety.

### FIELD OF THE DISCLOSURE

The present disclosure generally relates to a virtual instruction and more particularly to systems and methods for interactive scenario-based medical instruction.

### BACKGROUND OF RELATED ART

Medical education is often compared to “drinking from a fire hydrant.” Medical students are expected to absorb, master and retain an extreme variety and volume of highly technical information and to develop the skills required to effectively and appropriately interact with both patients and colleagues and respond to the demands of being a practicing physician—all during the four, short years of medical school, and during continued graduate medical education. At the same time, student-patient interaction in the medical school environment has been increasingly decreased due to various policy and medical-legal pressures and changes. For example, while students were previously afforded the opportunity to directly interact with and learn from actual patients in hospital-settings, various medical laws (e.g. HIPAA laws) have severely restricted the frequency and substance of patient interaction and on-site learning that students may expect. Although role-playing games (RPGs) are known in the art, the majority of prior art RPGs are designed for entertainment purposes, rather than educational and/or training purposes.

### SUMMARY

The present invention relates to systems and methods for providing a framework (e.g. software, hardware, firmware, etc.) that will allow students and health professionals to learn and practice medical principles and refine essential skills in a virtual environment. The disclosed framework allows students (users) to interact with virtual patients in various scenarios, exposing users to medical illnesses and conditions. For example, the disclosed framework allows users to identify and manage different illnesses and conditions that may not be common in their geographic location, and exposes users to patient types and ethnic groups that they may not be exposed to otherwise. The disclosed framework also allows users to operate on flexible timeframes—for example, the disclosed framework can be configured to operate on a realistic timeframe, or an accelerated timeframe, according to a user's or instructor's preference.

The disclosed framework may be used by students in various medical and related specializations, including nursing, pharmaceutical, dental, veterinarian, and/or any other appropriate program/specialization. Additionally, the disclosed framework may be used by physicians and other professionals for receiving additional training such as in the context of continuing education, hospital training, and/or any other appropriate practice area specific training programs.

The disclosed system may be implemented in association with any computing device, for example a personal computer, a mainframe computer, a personal-digital assistant (“PDA”), a cellular telephone, a mobile device, a tablet, an e-reader, or the like. Moreover, the disclosed framework may be run from a hosted server (e.g., web-based training, connected via a LAN, etc.), streaming server, via downloaded software (e.g., purchased software, IT server pack, etc.), installed software (e.g., at an authorized training site, university, etc.), specialized electronic apparatus, and/or any other appropriate means.

### BRIEF DESCRIPTION OF THE DRAWINGS

FIG. 1 illustrates in block diagram form components of an example, computer network environment suitable for implementing example cross referencing systems disclosed.

FIG. 2 depicts a flowchart illustrating on example of the general structure of an interactive scenario in accordance with the disclosed framework.

FIG. 3 illustrates an example flow of a scenario in an emergency room environment.

FIG. 4 illustrates an example flow of a scenario in a hospital environment.

FIG. 5 illustrates an example flow of a scenario in a clinical environment.

FIG. 6 illustrates an example graphical user interfaces associated with a first scenario in accordance with the present disclosure.

FIG. 7 illustrates an example graphical user interface associated with a second scenario in accordance with the present disclosure.

FIG. 8 illustrates an example graphical user interface associated with a third scenario in accordance with the present disclosure.

FIG. 9 illustrates an example graphical user interface associated with a fourth scenario in accordance with the present disclosure.

### DETAILED DESCRIPTION

The following description of example methods and apparatus is not intended to limit the scope of the description to the precise form or forms detailed herein. Instead the following description is intended to be illustrative so that others may follow its teachings.

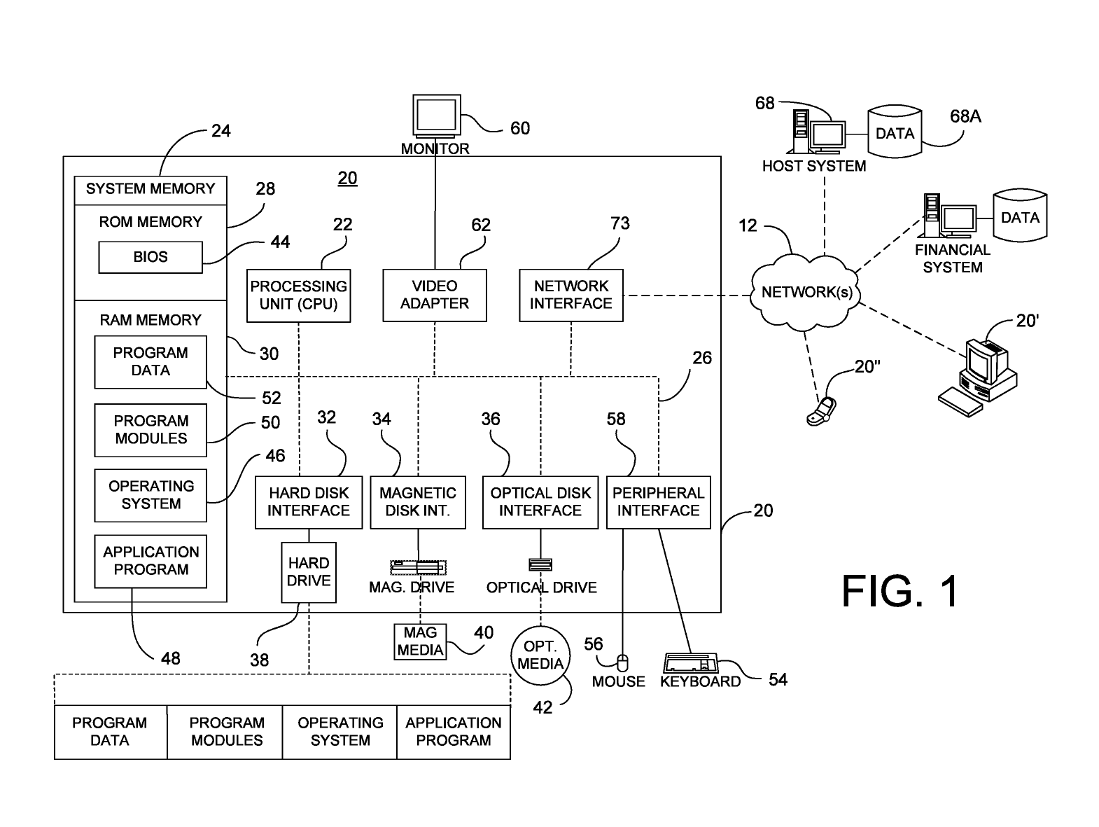

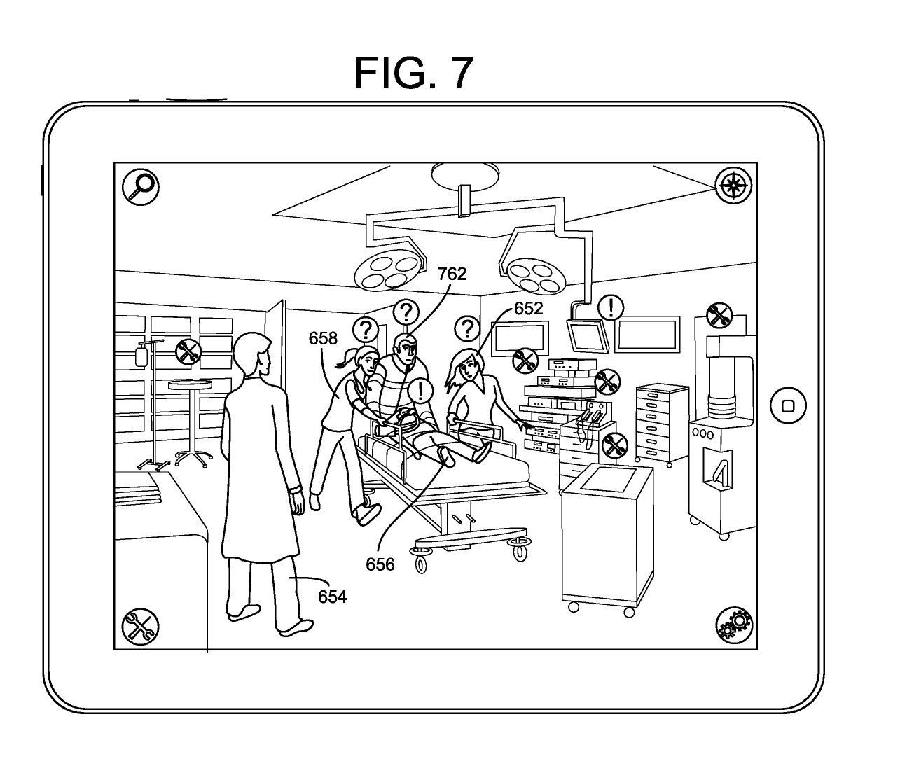

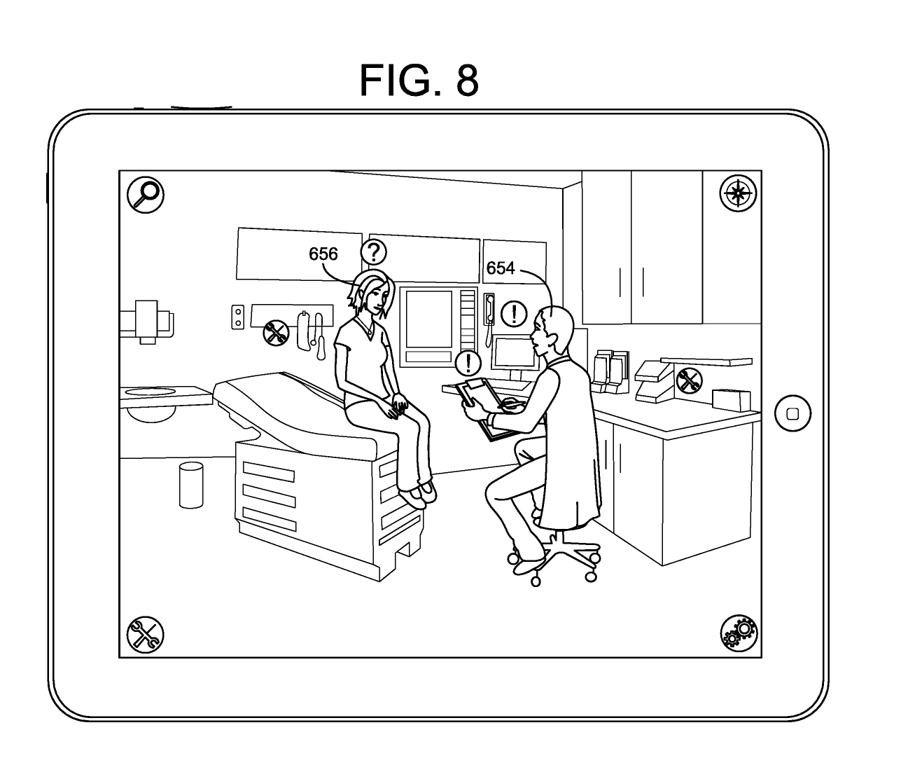

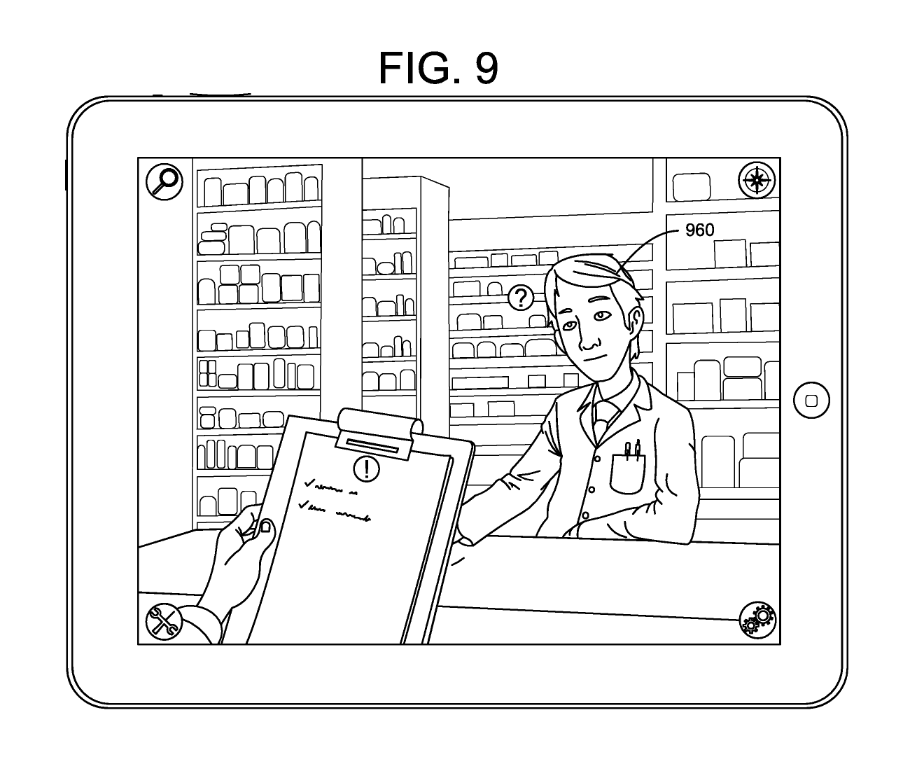

Referring to FIGS. 1-9, in at least one example, the present disclosure is related to a framework designed in a format similar to a role-playing game (RPG). In one embodiment, the user may be represented by one of a plurality of avatars (or graphical representation), or the framework may depict the user in the first-person, who is not visually represented by the framework. Alternatively, the user may choose between a first-person or third-person experience and the framework will adjust accordingly. Furthermore, the user may choose which role to inhabit in accordance with the framework. For example, the user may choose to play the role of the physician, but the user may also play the role of a patient, nurse, attending physician, receptionist, family member, and/or any other appropriate role. Furthermore, it is contemplated that the user may inhabit more than one role in a given session, simultaneously.

In the context of the medical education environment, the present invention operates to log the user's activities and interactions in a database that can be accessed by his or her instructors. As described below, the invention can be configured to present various predefined scenarios to the user whereby the user's responses/interactions are monitored, evaluated, and/or graded.

One of ordinary skill in the art will recognize that the framework can be configured to allow multiple users to interact, collaborate, communicate, share user-created content, etc. For example, the framework may allow a user to interact with its peers, classmates, instructors, lecturers, members of the user's social networks, experts, etc. Additionally, the framework may restrict the rights, security settings, information, etc. provided to a user based upon the user's identity and/or permissions. For instance, instructors may have access to all students' responses, grades, progress reports, user-created content, etc. However, a first user may not access a second user's responses, grades, progress report, user-created content, etc. unless the second user grants permission. Still further, it will be appreciated by one of ordinary skill in the art that system disclosed herein may be presented in any language and/or format as desired.

The disclosed framework allows users to access and interact with virtual scenarios related to their medical training. The framework functions to provide a wide range of practice scenarios, including predefined scenarios, instructor-created scenarios, user-created scenarios, collaborative-created scenarios, and/or dynamically generated scenarios. The scenarios depict environments (e.g., an emergency room, hospital room, clinic, doctor's office, etc.), individuals, (e.g., patients, family members, medical personnel, etc.) and inanimate objects (x-ray machines, medical devices, etc.) and present one or more medical conditions which the user must respond to and “treat”. Users interact with the people and objects depicted in the scenario, ask questions, make notes, recommend action, review labs, radiology reports, and other data as well as writing orders consistent with the act of treating the patient, etc. whereby the users mimic an actual environment as closely as possible without physically treating an actual patient.

In accordance with the disclosure, the user may interact with the disclosed environment to diagnose illnesses, perform appropriate laboratory work-ups, order appropriate radiological studies, interview the patient, family members, and other medical personnel in order to treat the virtual patient. To further mimic a real-life medical environment, a user may be “on call” for a virtual hospital, and the framework will notify the user when a patient needs to be admitted. Once the user is notified of an admission, the user must log into the framework, perform the required diagnostics and if appropriate, admit the patient and create admission orders. For instance, in one example, to mimic a real-life medical environment, the user may get a notification from the “virtual” nurse that the patient is complaining of an ailment, such as a headache. The user would then be expected to order a medication such as Tylenol to treat the patient's complaint. The disclosed framework allows a user to treat a patient from the entire duration of admission through discharge—which may take several calendar days, creating a patient lifecycle management scenario in real-time, over-time. In accordance with the disclosure, the user may make admission decisions, create admission notes, progress notes, operative notes, and death notes, give orders to other medical personnel, write virtual prescriptions, decide to discharge, and/or take any other action that is typical in a medical environment.

One of ordinary skill in the art will recognize that the user's notes and inputs will be in various forms, including typing, selecting between multiple choices, creating a voice recording, creating a video recording, etc.

The disclosed framework offers users the ability to manage patients in multiple specialties such as pediatrics, family practice, geriatrics, internal medicine, obstetrics and gynecology, psychiatry, etc. As one of ordinary skill in the art will appreciate, the user, instructor, or any other appropriate administrator may set the framework to only display scenarios related to certain specialties. The disclosed framework also gives a user the ability to identify, explore, and treat both acute and chronic illnesses.

Moreover, in addition to diagnosing and treating an admitted patient, the user may prescribe follow-up treatment and manage patients after discharge, which allows a user to manage patients over long periods of time. For example, a user may get calls or notifications from a virtual nurse or from a patient about post-discharge complications (e.g., nausea, headache, constipation, or pain). As a result the user may make a further diagnosis, order follow-up, write a new prescription, etc.

The framework also includes interactive features, which allow the user to interact with other virtual and real users. At various times the user may receive (automatically, or in response to an inquiry) various information from other virtual individuals and objects, which may inform the user's decisions and treatment. For example, the user may receive pertinent information from family members (e.g., family history, patient's medical history, patient's behavior, etc.), other medical personnel (e.g., lab results, vital signs, patient updates etc.), objects (e.g., patient measurements, temperature readings, etc.), and/or directly from the patient. In another example, the framework may provide a virtual attending physician who may advise the user by giving pertinent advice and management strategies. Additionally, real-life instructors, professors, or administrators may track a user's progress and feedback, advice and notes.

The disclosed framework may provide scores based on the user's performance in a medical scenario. Those scores may be automatically generated, graded by an instructor, graded by peers, etc. The scores may be based on outcomes, patient history, knowledge applied, best health practices, etc. The activity log maintained by the framework can be reviewed by instructors toward providing further feedback to the user.

While one embodiment of the present invention contemplates interaction with the framework via typing or text, it is further contemplated that an alternative embodiment can incorporate synthesized human voice and voice recognition whereby the user can interact using spoken voice and the framework will accept and respond to the user's voice.

Additionally, the framework may provide the user with access to pertinent information while they are managing the patient's condition, such as tutorials, medical references, links to textbooks, links to journal articles, etc. These secondary sources may be provided automatically, on-demand, based on a user's score, based on a user's search, etc.

The architectural structure of the disclosed platform is also designed to collect, obtain, store, sort, track, monitor, analyze, predict, and distribute its data. This structure is the nucleus that supports and creates the disclosed patient management system.

With reference to the figures, and more particularly, with reference to FIG. 1, the following discloses various example systems and methods for providing an interactive scenario-based medical instruction on a computer, such as a personal computer or mobile device (e.g., a tablet device). To this end, a processing device 20″, illustrated in the exemplary form of a mobile communication device, a processing device 20′, illustrated in the exemplary form of a computer system, and a processing device 20 illustrated in schematic form, are provided with executable instructions to, for example, provide a means for a user, e.g., a student, teacher, etc., to access a host system server 68 and, among other things, be connected to a hosted scenario based education instruction, e.g., a website, mobile application, etc. Generally, the computer executable instructions reside in program modules which may include routines, programs, objects, components, data structures, etc. that perform particular tasks or implement particular abstract data types. Accordingly, those of ordinary skill in the art will appreciate that the processing devices 20, 20′, 20″ illustrated in FIG. 1 may be embodied in any device having the ability to execute instructions such as, by way of example, a personal computer, a mainframe computer, a personal-digital assistant (“PDA”), a cellular telephone, a mobile device, a tablet, an ereader, or the like. Furthermore, while described and illustrated in the context of a single processing device 20, 20′, 20″ those of ordinary skill in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules, and other data for the processing device 20. Those of ordinary skill in the art will further appreciate that other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices, or other stoirage device, such as a cloud-based storage device. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser, computer App, etc), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 (physical or virtual) and/or a pointing device 56 are provided. While not illustrated, other input devices may include a microphone, a joystick, a game pad, a scanner, a camera, touchpad, touch screen, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more local and/or remote processing devices, such as the host system server 68 having an associated data repository 68A. The example data repository 68A may include any suitable educational data including, for example, medical situation scenarios, etc. In this example, the data repository 68A is stored locally to the device 20 and includes data relevant to various educational roles, such as for example, student, teacher, class, etc. medical resources, such as dictionaries, text-books, guidelines, etc., and/or medical situations. In this regard, while the host system server 68 has been illustrated in the exemplary form of a computer, it will be appreciated that the host system server 68 may, like processing device 20, be any type of physical and/or virtual device having processing capabilities. Again, it will be appreciated that the host system server 68 need not be implemented as a single device but may be implemented in a manner such that the tasks performed by the host system server 68 are distributed amongst a plurality of processing devices/databases located at different geographical locations and linked through a communication network. Additionally, the host system server 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of education, teaching, hospital, insurance, resource, etc.

For performing tasks as needed, the host system server 68 may include many or all of the elements described above relative to the processing device 20. In addition, the host system server 68 would generally include executable instructions for, among other things, facilitating the ordering of a vendor product, facilitating a cross reference of inventory numbers, facilitating recommendations, providing access to merchandise purchasing, etc.

Communications between the processing device 20 and the host system server 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, it will be appreciated that program modules depicted relative to the processing device 20, or portions thereof, may be stored in the non-transitory memory storage device(s) of the host system server 68.

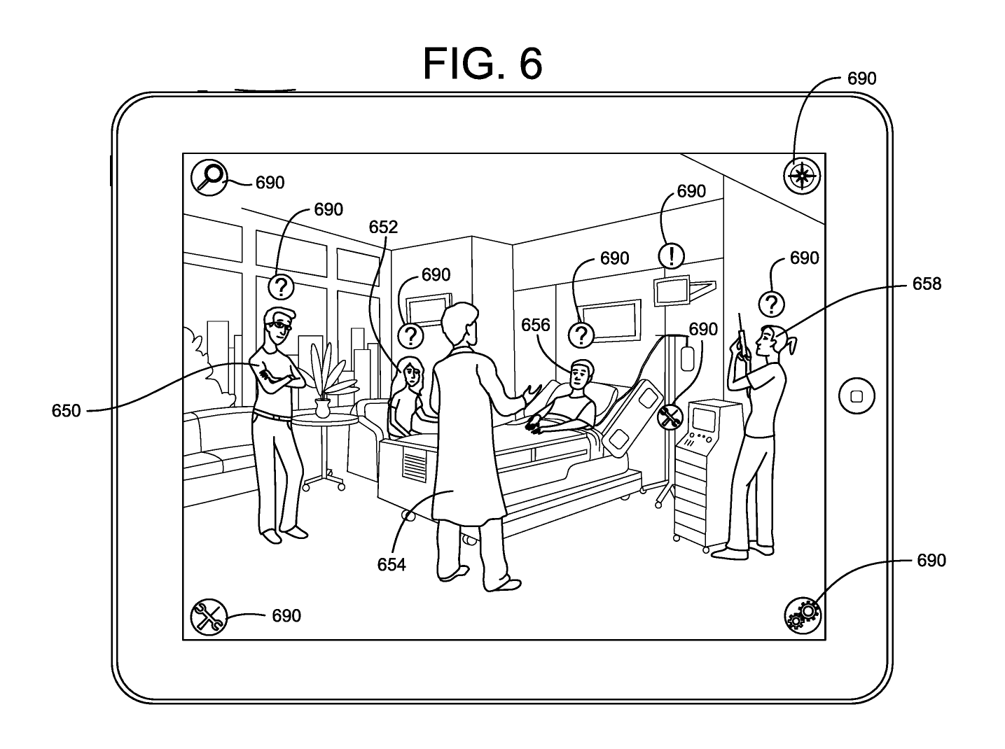

As noted above, in the present example, a user generally interacts with the device and/or the host system server 68 to participate in variously designed educational scenarios. To facilitate this process, the host system server 68 provides graphical access to various teaching scenarios including, for example, a hospital room, an emergency room, a doctor's office, or a pharmacy, etc. displayed on the client computing device 20. More particularly, as illustrated in the examples of FIGS. 6-9, the host system server 68 provides in direct association with an specific scenario maintained in the data repository 68A, an access point presented in the form of a user interface (graphical user interface, web-based user interface, touchscreen user interface, etc), such as at least interactive display element, by which the user may interact with and/or proceed along the desired teaching scenario.

Specifically, several example virtual scenarios are described, in accordance with the present disclosure, with the understanding that the present invention is not limited to the specific scenarios or practice areas described.

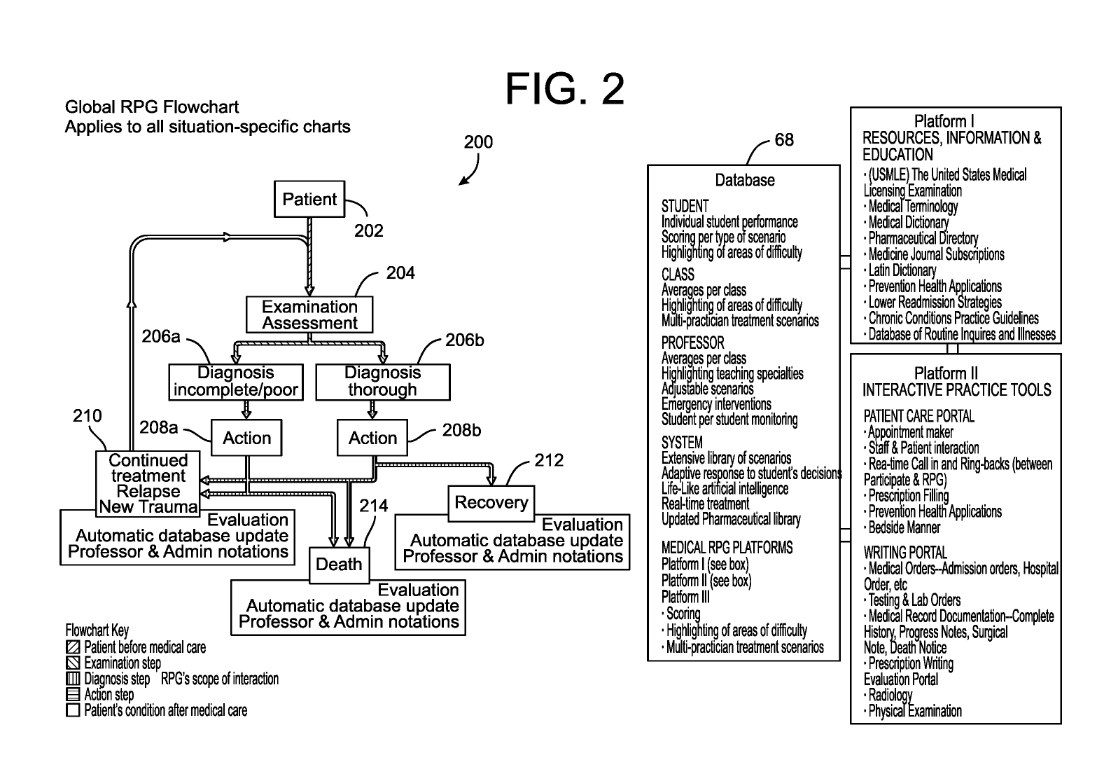

Referring to FIG. 2, a general framework process 200 is illustrated showing the general flow of various scenarios running on the device 20. In this example, a patient is generally presented to the user for treatment at a block 202. As noted, the history and/or data related to the patient scenario may be accessible to the user through the data repository 68. Once the patient is presented, a virtual examination by the user occurs at a block 204. The virtual examination may comprise interviews, physical examinations (virtual examination), lab tests, etc. Once the examination occurs, a diagnosis by the user may be rendered. In the situation where the diagnosis is incomplete and/or poor, through failed examination or otherwise (block 206a), the action prescribed at block 208a may include additional examination and/or partial treatment. I the situation where the diagnosis is thorough (block 206b), the action prescribed at block 208b may be the final treatment authorization.

Based upon the actions prescribed by the user at blocks 208a, 208b, the process 200 may virtually cause the patient to continue treatment at block 210 requiring additional input (e.g., evaluations, etc) by the user, may result in the recovery of the patient at block 212, or may unfortunately result in the expiration of the virtual patient at block 214. It will be appreciated by one of ordinary skill in the art that the general process flow may vary widely based upon any number of conceived scenarios related to education situations.

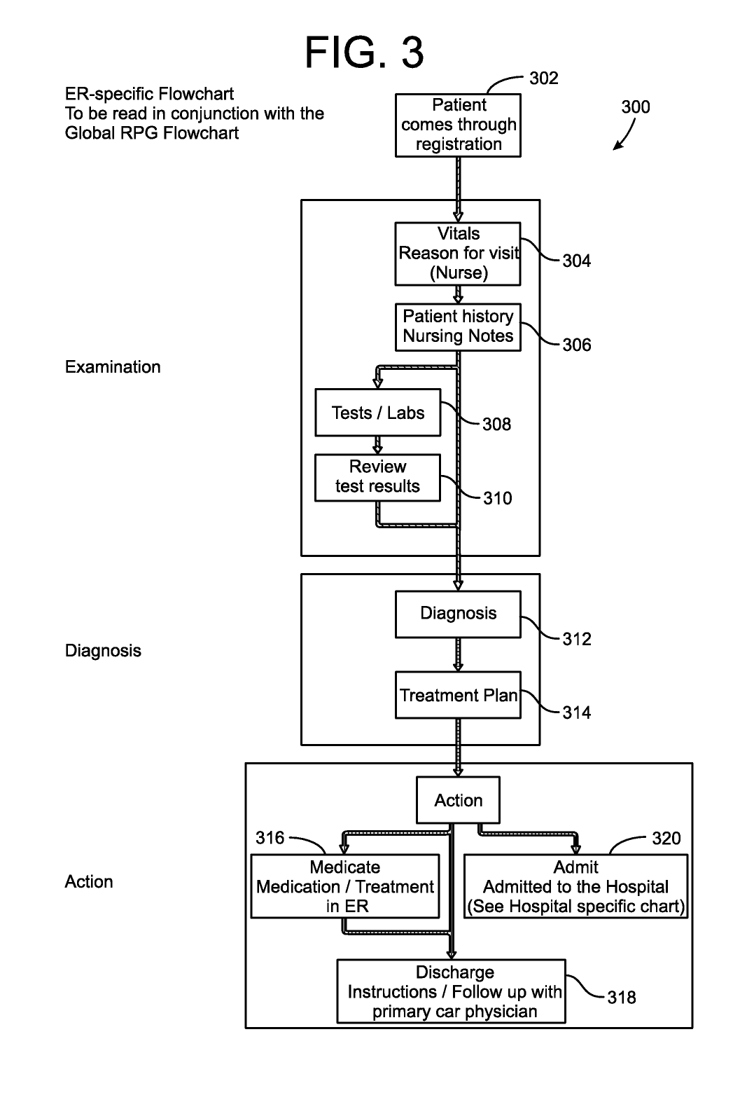

Referring now to FIG. 3, a first example scenario 300 operating on the device 20, and in the process 200 framework is set in an emergency room (ER), wherein the following example events occur. At a block 302, a patient comes to the ER and passes through registration. At a block 304, a nurse takes vitals and at block 306 identifies the reason for the ER visit. Typically, the patient is placed in a virtual exam room by nurse, and a doctor (or user) enters to introduce him/herself. The doctor (or user) asks for the patient history from patient and from the nurse's notes, the doctor (or user) conducts an initial examination, and the doctor (or user) orders test and/or lab work at block 308. The virtually examination of the patient may include, in any sequence order, from head to toe, including (i) head, ears, eyes, nose, and throat; (ii) heart; (iii) lungs and chest; (iv) abdomen; and (v) extremities. The doctor may exam each of these areas using the appropriate device, choosing from a stethoscope, otoscope, ophthalmoscope, reflex hammer, etc. The doctor (or user) may then leave to go see another patient while waiting for the test and/or lab work results (such as for example in real-time). Once received, the doctor (or user) reviews the test results at a physician workstation at block 310. At a block 312, the doctor (or user) makes a diagnosis and at a block 314, prepares a treatment plan based upon labs, test, patient history, etc. The doctor (or user) may then return to the patient to communicate the treatment plan to the patient.

In the example emergency room scenario 300, the doctor may choose to: (i) medicate (block 316) e.g. provide medication and/or treatment in the ER and then discharge the patient with follow-up instructions for a primary care physician, etc.; (ii) discharge (block 318) discharge the patient with a prescription, instructions for treatment, follow-up instructions for a primary care physician, etc.; or (iii) admit (block 320) admit the patient into the hospital; the ER doctor (or user) calls another doctor (i.e. a specialist) to accept patient. The framework can be configured to present patients having predetermined or randomly selected conditions or symptoms that require treatment. The framework can be configured to present conditions or symptoms based upon the user's past performance and/or in parallel with a particular course of study.

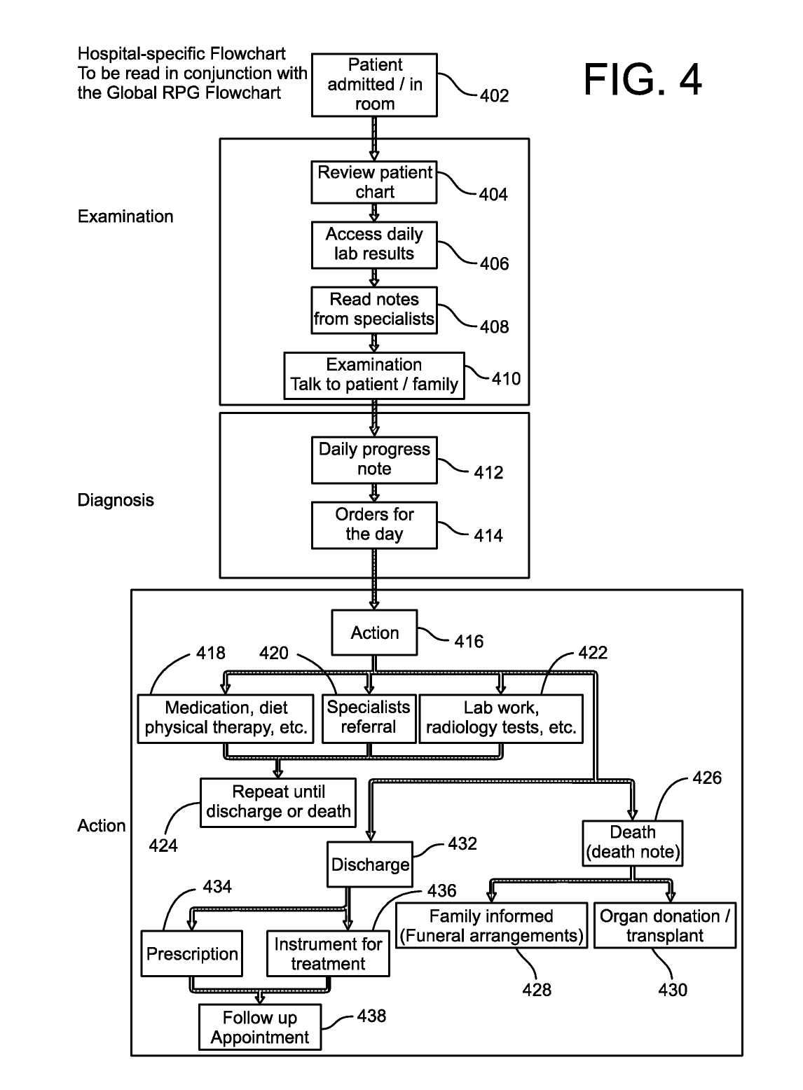

Referring to FIG. 4, a second example scenario 400 is set in a hospital, doctor's office or clinic, wherein the following example events occur. At block 402, a patient is admitted to an examination room. A doctor (or user) goes to the Nursing Station. At block 404, the doctor (or user) pulls and reviews a patient chart, e.g., the doctor (or user) accesses labs drawn that morning (block 406), and reviews the patient's chart from the day before. The doctor (or user) reads notes from a specialist (i.e. a cardiologist, otolaryngologist geriatrician, gerontologist, gynecologist, hematologist, internist, neurologist, obstetrician etc.) at block 408. The doctor (or user) then goes into the examination room to see the patient at block 410, wherein the doctor (or user) communicates with the patient and family members and examines patient. The virtual examination of the patient may include, in any sequence order, from head to toe, including (i) head, ears, eyes, nose, and throat; (ii) heart; (iii) lungs and chest; (iv) abdomen; and (v) extremities. The doctor may exam each of these areas using the appropriate device, choosing from a stethoscope, otoscope, ophthalmoscope, reflex hammer, etc.

Once complete, the doctor (or user) returns to the Nursing Station, or other location, to write his daily progress note on the patient's chart (block 412) and his orders for the day (block 414). As will be appreciated, the doctor's (or user's) orders (ie., actions 416) may include medications (block 418), specialist referrals (block 420), diet, lab work or radiology tests (block 422), physical therapy, prescription, instrument for treatment, request for a follow-up appointment, etc.

For a given patient, assuming repeated visits, this process is repeated at block 424. However, if the patient passes away (block 426), the process is not repeated, and the doctor (or user) will write a death note, and inform the family, if the family is not present. The doctor (or user) may also ask the family about choice of funeral arrangement, notify organ donation and transplant teams, and notify the coroner (block 428, 430).

Still further, the patient may be discharged (block 432) from further treatments with long-term prescriptions (block 434) and/or treatment instruments or devices (block 436) with instructions for follow-up appointments if necessary.

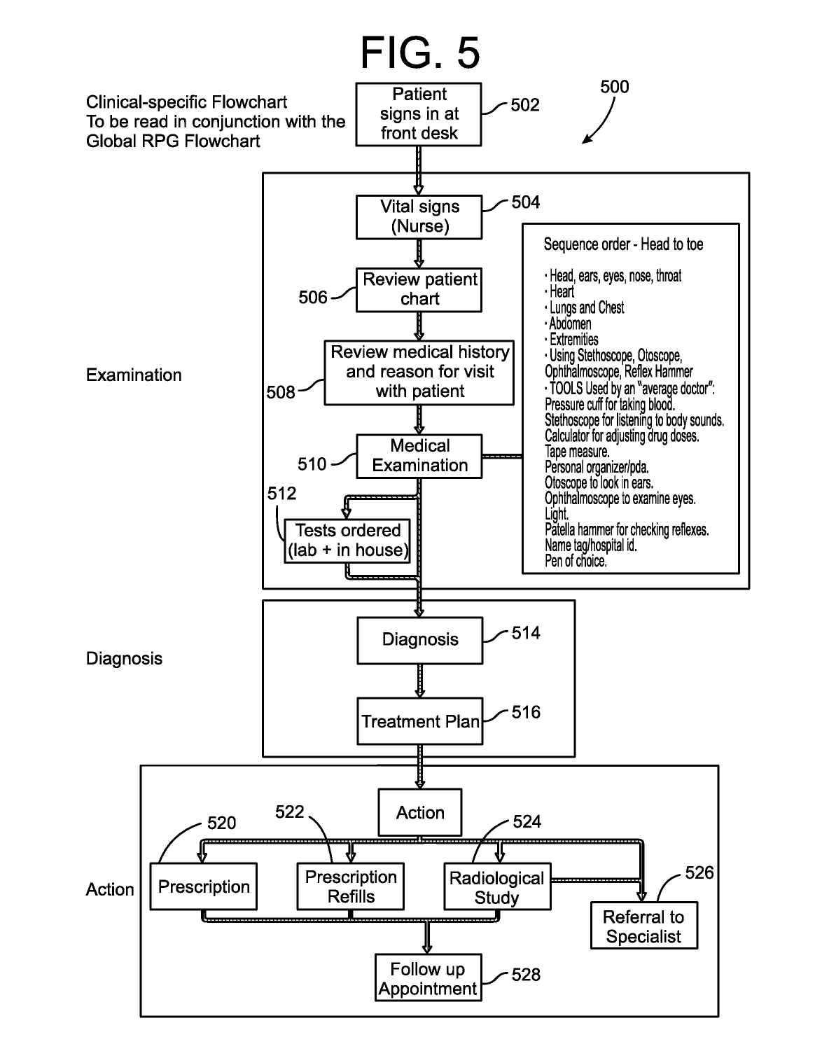

FIG. 5 illustrates a third example scenario 500, set in a doctor's office or other clinical setting, wherein the following events occur. At block 502, a patient comes into the clinic, for example, the patient may sign in at front desk, provides insurance information, makes the appropriate payment, and wait in the waiting room. At block 504, a nurse calls the patient's name and leads patient to an exam room, taking the patient's vital signs, including height (using a virtual scale), weight (using a virtual scale), blood pressure (using a virtual sphygmomanometer), heart rate (using a stethoscope), and oxygen level (using an oxygen saturation device). At a block 506, a doctor (or user) reviews the patient's chart. The doctor (or user) then enters the exam room to meet with the patient, and discusses the patient's medical history and reason for visit at block 508. At a block 510, the doctor (or user) virtually examines the patient in any sequence order from head to toe, including (i) head, ears, eyes, nose, and throat; (ii) heart; (iii) lungs and chest; (iv) abdomen; and (v) extremities. The doctor may exam each of these areas using the appropriate device, choosing from a stethoscope, otoscope, ophthalmoscope, reflex hammer, etc. The doctor (or user) may also order certain tests at block 512, which may include (i) in-office tests, such as strep screen, urinalysis, flu test, etc. or (ii) out-of-office tests including labs drawn and sent to a lab.

Once the examination is complete, the doctor (or user) reviews results from in-house tests at block 514. The doctor (or user) then prescribes a treatment plan at block 516. The treatment plan may require some action, such as for example, writing a prescription (block 520); refilling a prescription (block 522); referral to a specialist (block 526), order for radiological study (block 524); order for follow-up appointment (block 528); and/or any other appropriate treatment orders.

In accordance with the disclosed framework, the user may undertake certain general modes of analysis, or diagnostic techniques to determine the ailment and the appropriate treatment. For example, the user may have to determine whether a patient is experiencing chronic or acute pain. Acute pain is defined as pain that has an expected short course of duration, such as a broken bone, headache, ankle sprain, etc. Chronic pain is defined as pain that will continue for long periods of time, such as osteoarthritis, herniated disk, etc. By determining whether the pain is chronic or acute in nature, the user may more accurately identify the illness and provide the appropriate treatment. For example, if a patient complains of lower back pain, the doctor may determine whether the pain is acute or chronic and prescribe various outcomes accordingly, e.g., pain medication, a muscle relaxer, narcotic, etc.

In another example diagnostic technique, a doctor may notice that the patient has high blood pressure. The user may assess whether the patient recently experienced any changes in lifestyle or whether the patient is currently taking any medication that could cause the rise in blood pressure. After the user completes this analysis the user may prescribe various outcomes, including new medication, changes to medications such as increasing or decreasing dosages, etc. The user may also recommend that the patient make lifestyle adjustments such as a healthy diet, and exercise, and set up a follow-up appointment.

In yet another example diagnostic technique, a patient may complain about pain on the right side of her back and frequent urination. After the user speaks with the patient, orders a urinalysis, and reviews the results, the user may prescribe the appropriate antibiotic.

It is contemplated that the framework can be configured such that the user is required to work in multiple scenarios and/or with multiple patients simultaneously. It is additionally contemplated that the user receives notifications during the day or night that a virtual patient requires attention. The user would then log into the framework and interact in furtherance of the scenario to respond to the patient's needs.

The disclosed framework may be separated into three separate functionalities, or platforms. The first platform of the disclosed framework provides resources to the user. This may include medical references such as: The United States Medical Licensing Examination (USMLE); medical terminology directory; medical dictionaries; pharmaceutical directory; medical journal subscriptions; Latin dictionary; preventative health applications; lower readmission strategies; chronic conditions practice guidelines; database of routine inquiries and illnesses; specialist directory; etc.

The second platform consists of interactive/virtual tools for the user. One aspect of the interactive platform includes a portal for the user to access virtual medical scenarios. For example, this portal allows users to interact with patients, individuals, and the virtual environment; make appointments; receive and send communications with virtual individuals (e.g. patient updates, notifications, real-time call-in, ring-backs, etc.); call in prescriptions; participate in preventative care; practice appropriate bedside manner; etc. Additionally the interactive platform allows users to create content, including writing notes (personal notes, notes to peers, notes to instructors, etc.); medical orders (e.g., admission orders, hospital orders, testing and lab orders, etc.); medical record documents (e.g., complete history, progress notes, surgical notes, death notes, etc.); prescription writing; etc. The interactive platform also allows users to receive virtual information that the user may evaluate visually, such as lab results (e.g., radiology results, imaging, etc.), physical examination, etc. The interactive platform further allows users to interact with virtual versions of commonly used medical tools, such as a pressure cuff, stethoscope, calculator, tape measure, personal organizer, otoscope, ophthalmoscope, light, patella hammer, a name tag, hospital ID, pen, etc.

The third platform of the disclosed framework comprises evaluation resources for the user. This includes user profiles, scoring (automatic or manual scoring) and reporting. According to the present disclosure, the framework may also be compatible with various accreditation and medical education certification programs, such as continuing education training, etc. A fourth platform of the disclosed framework may include the metrics that may be possible such as predicting risk of a user to have a malpractice case or areas of weakness that a group of students may have that may prompt a medical school to focus more attention in that area.

As previously noted, FIG. 2 depicts a flowchart illustrating the general structure of an interactive scenario in accordance with the disclosed framework. As shown in the flowchart, the user first receives a patient, the user then performs an examination, the user gives a diagnosis, and then the user prescribe a recommended action, which leads to a certain patient result. At each step the framework may carry out one of a number of divergent options, depending on the user's performance, system settings, instructor input, or any other appropriate factors.

As illustrated in FIG. 2, the framework comprises a database that stores various scenario options in a scenario library, and those scenarios may be informed and affected by medical databases/references (e.g., a pharmaceutical library, medical textbooks, etc.). Moreover, the database also stores user information, such as the user's profile, user's performance, user-created content, user notes, etc. The database also provides controls functions available to a professor/instructor/administrator, including student analysis, the ability to adjust and refine scenarios, emergency interventions, monitoring, etc.

FIG. 2 also illustrates the relationship between example scenarios and the framework's organizational platforms, which are described above. For instance, the user may access the first platform, comprised of resources and references, to remind, confirm, and/or reinforce the user's medical knowledge as the user participates in a scenario. The framework also allows users to access the interactive practice tools of the second platform in conjunction with a scenario. For example, the user may use second platform tools to make appointments, write prescriptions, write notes, etc. as necessary in a scenario.

FIGS. 3-5 are flowcharts that illustrate example interactive scenarios for various environments in accordance with the present disclosure. FIGS. 3-5 illustrate events, steps, and decisions that a user may encounter in the examination phase, diagnostic phase, and action phase under different circumstances. FIG. 3 illustrates an example flow of a scenario in an emergency room environment. FIG. 4 illustrates an example flow of a scenario in a hospital environment. FIG. 5 illustrates an example flow of a scenario in a clinical environment.

FIGS. 6-9 are example graphical user interfaces associated with various scenarios in accordance with the present disclosure. As shown in FIGS. 6-9, the graphical user interfaces depict environments, individuals (such as patients 656, family members 650, 652, nurses 658, pharmacists 960, medical personnel 654, emergency personnel 762, and/or the user), as well as various other objects. FIGS. 6-9 also shows various interactive “hotspots” 690 in the scene, and which may be associated with an individual, object, or part of the environment. These hotspots may provide information, ask questions, provide measurements, answer questions, link to other content, and/or perform any other appropriate interaction. The hotspots may be activated when selected by the user, activated automatically, or triggered in response to another related event. The framework may depict the hotspots with a visual cue (e.g., a button, shading, text box, etc.), or the hotspots may be invisible. If the hotspots are represented by visual cues, the visual cue may further indicate the type of interaction that the user may expect (e.g., data, comments, questions, answers, etc.). As will be understood by ordinary skill in the art, the interaction may be text-based, audio, graphical, animated, etc.

In addition, the example graphical user interfaces depicted in FIGS. 6-9 comprise links to other resources at the four corners of each user interface. These links may lead to resources and references available via the framework's first platform; interactive practice tools associated with the framework's second platform; search tools; user settings; the user profile; sharing capabilities; links to outside applications (e.g., email, social networking, etc.) and/or any other appropriate linked material.

Although certain example methods and apparatus have been described herein, the scope of coverage of this disclosure is not limited thereto. On the contrary, this disclosure contemplates all other methods, apparatus, and articles of manufacture fairly falling within the scope of the disclosure and appended claims either literally or under the doctrine of equivalents.

We claim:

1. A computer-implemented method of providing medical instruction comprising:
displaying a virtual environment to a first user comprising at least one patient, at least one non-patient individual, and at least one object;
upon receiving a first input from the first user, providing information relating to the at least one patient;
upon receiving a second input from the first user, providing information from the non-patient individual; and
upon receiving a third input from the first user, providing information from the object.

2. A method of claim 1, further comprising engaging the first user in a patient life cycle management in real-time, over time.

3. A method of claim 2, further comprising presenting multiple scenarios in various clinical settings in the virtual environment.
